(19) United States
(12) Patent Application Publication
(10) Pub. No.: US 2024/0391438 A1
(43) Pub. Date: Nov. 28, 2024

(54) Brake Device for a Hydraulic Brake System of a Vehicle and Method for Operating a Hydraulic Brake System of a Vehicle

(71) Applicant: Robert Bosch GmbH, Stuttgart (DE)

(72) Inventors: Jan Mutschler, Sulz am Neckar (DE); Alessandro Moia, Holzgerlingen (DE)

(21) Appl. No.: 18/695,262

(22) PCT Filed: Oct. 5, 2022
(86) PCT No.: PCT/DE2022/100738

§ 371 Date: Mar. 25, 2024

(30) Foreign Application Priority Data
Oct. 5, 2021 (DE) 10 2021 211 201.3

(51) Int. Cl. B60T 13/14

(52) U.S. Cl. CPC B60T 13/142; B60T 2270/10

(57) ABSTRACT

A brake device for a hydraulic brake system of a vehicle is disclosed. The brake device includes a piston which can be adjusted within an accumulator volume and divides the accumulator volume into a first partial volume and into a second partial volume. A brake cylinder which is device-inherent or device-external is attached or can be attached to the first partial volume. A wheel brake cylinder which is device-inherent or device-external is attached or can be attached to the second partial volume. The brake device further includes a bypass line. A check valve which is arranged in the bypass line can be switched by way of the piston in such a way that the check valve is in an open state at least in the case of the piston being in its normal position, and is switched into a closed state by way of the piston which is adjusted out of its normal position by at least one minimum adjustment travel. Also disclosed is a method for operating a hydraulic brake system of a vehicle.

The invention relates to a brake device for a hydraulic brake system of a vehicle and a hydraulic brake system for a vehicle. The present invention further relates to a method for operating a hydraulic brake system of a vehicle.

### PRIOR ART

EP 3 124 344 A1 describes a brake system for a vehicle comprising a hydraulic actuator device whose pistons, which can be adjusted by means of a motor of the actuator device, divide an accumulator chamber of the actuator device into a first partial volume and into a second partial volume. The first partial volume of the accumulator chamber on a first side of the adjustable piston is hydraulically attached to a brake cylinder in such a way that when an actuation of a brake actuation element attached to the brake cylinder increases or decreases, brake fluid can be transferred between the brake cylinder and the first partial volume of the accumulator chamber. The second partial volume of the accumulator chamber on a second side of the piston is hydraulically attached to a wheel brake cylinder, and therefore brake fluid can be transferred between the second partial volume of the accumulator chamber and the wheel brake cylinder. In addition, the wheel brake cylinder is hydraulically attached to a bypass, which, when the adjustable piston of the actuator device is in a normal position, opens into the first partial volume of the accumulator chamber in such a way that brake fluid can also be transferred between the brake cylinder and the wheel brake cylinder via the bypass. The adjustable piston of the actuator device is held in its normal position by means of a spring. However, the adjustable piston of the actuator device may be moved against the force of the spring out of its normal position by means of its motor, whereby the hydraulic connection between the brake cylinder and the wheel brake cylinder, which runs via the bypass, is interrupted when the piston is adjusted out of its normal position by at least one predetermined minimum adjustment travel. After interrupting the hydraulic connection between the brake cylinder and the wheel brake cylinder, it should be possible to modulate a brake pressure present in the wheel brake cylinder by a further displacement of the adjustable piston of the actuator device.

However, the operation of the actuator device of the brake system of EP 3 124 344 A1 described in the preceding paragraph requires the adjustable piston to have a first surface on its first side adjacent to the first partial volume of the accumulator chamber, which is larger than a second surface of the piston on its second side adjacent to the second partial volume of the accumulator chamber. In addition, the piston only seals the first partial volume of the accumulator chamber from the second partial volume of the accumulator chamber in a liquid-tight manner if a first pressure present in the first partial volume is greater than a second pressure prevailing in the second partial volume. This means that the motor of the actuator device has to overcome both a pressure difference between the first pressure and the second pressure and a surface difference between the first surface on the first side of the piston and the second surface on the second side of the piston in terms of force to adjust the piston out of its normal position.

### DISCLOSURE OF THE INVENTION

The present invention provides a brake device for a hydraulic brake system of a vehicle with the features of Claim 1, a hydraulic brake system for a vehicle with the features of Claim 9, and a method for operating a hydraulic brake system of a vehicle with the features of Claim 10.

### Advantages of the Invention

The present invention provides advantageous ways to ensure a desired braking pressure in at least one wheel brake cylinder of a vehicle. The vehicle may be understood to mean both a vehicle with only two wheels and a vehicle having more than two wheels. The vehicle may be a vehicle without a motorized drive or a vehicle equipped with a motor drive. For example, the present invention may be used for a (muscle-powered) bicycle, a motorized two-wheeler, an electric bicycle, a motorcycle, and a motor vehicle such as a passenger car or a truck.

The present invention relates to brake devices or hydraulic brake systems, which, when the respective adjustable piston is in its normal position, brake fluid can be transferred between the brake cylinder attached to the adjacent first partial volume and the wheel brake cylinder attached to the adjacent second partial volume, while this transfer of brake fluid is prevented by means of the piston being adjusted out of its normal position by at least the predetermined minimum adjustment travel. However, in contrast to the prior art described above (with a first pressure in its first partial volume and a second pressure in its second partial volume), the adjustable piston of the brake device according to the invention (with the same first pressure in its first partial volume and the same second pressure in its second partial volume) can be adjusted out of its normal position by means of a lower force and with a significantly reduced energy consumption by the predetermined minimum adjustment travel.

The brake device according to the invention or the corresponding hydraulic brake system, therefore has significantly improved performance and significantly reduced energy consumption compared to the prior art described above. In addition, the present invention eliminates the weaknesses of the prior art while maintaining the range of functions and all the advantages of the prior art.

A realization of the present invention requires no further active components other than a check valve. A technical implementation of the present invention is therefore comparatively cost-effective and does not increase or hardly increases the design space requirement.

In an advantageous embodiment of the brake device, the piston has a cylindrical base body with a ring portion projecting from the base body, wherein the ring portion of the piston seals the first partial volume of the accumulator volume lying on a first side of the ring portion from the second partial volume of the accumulator volume lying on a second side of the ring portion in a liquid-tight manner, and wherein the cylindrical base body extends continuously from a first recess lying on the first side of the ring portion through the accumulator volume to a second recess lying on the second side of the ring portion. The cylindrical base body of the piston can thus also be described as a continuous piston rod. Accordingly, the piston may be referred to as a continuous piston. Due to the advantageous configuration of the piston described herein, adjusting the piston out of its normal position by at least the minimum adjustment travel when there is a first pressure in the first partial volume and a second pressure in the second partial volume requires a significantly lower force than in the prior art described above with the same first pressure in its first partial volume and the same second pressure in its second partial volume. This helps to additionally reduce the energy consumption of the embodiment of the brake device described herein.

Preferably, the piston is guided by means of at least one guide pin. In this way, the piston that has been adjusted from its normal position by at least the minimum adjustment travel or the piston that has been adjusted back to its normal position, can be reliably secured against undesirable rotations.

In a preferred embodiment of the brake device, the bypass line and the check valve are formed within the piston. By integrating the bypass line and the check valve into the piston, a design space requirement of the embodiment of the brake device described herein can be reduced while maintaining its range of functions.

Advantageously, when the piston is in its normal position, the check valve formed within the piston can be held in its open state by means of a plunger which is fixedly arranged on the brake device and projects into an opening of the piston, while the piston, which is adjusted out of its normal position by at least the minimum adjustment travel, is adjusted relative to the piston in such a way that the check valve is switched to its closed state. The use of the fixed/stationary plunger allows comparatively simple structural implementation of the piston with its check valve integrated in the piston and the bypass line running through the piston.

For example, the check valve formed within the piston may comprise a valve body and a spring device, wherein the valve body is held away from a constriction formed at the opening of the piston against a force of the spring device when the piston is in its normal position by means of the plunger projecting into the opening of the piston, while after the piston has been adjusted out of its normal position by at least the minimum adjustment travel, the force of the spring device pushes the valve body against the constriction in such a way that, by means of the mechanical contact of the valve body with the constriction, an outer portion of the opening lying on a first side of the constriction is sealed in a liquid-tight manner from an inner portion of the opening lying on a second side of the constriction. The configuration of the piston described herein is comparatively cost-effective to manufacture.

In particular, the bypass line formed within the piston may comprise a first radial contact bore through the piston extending from the first partial volume of the accumulator volume to the inner portion of the opening, and a second radial contact bore through the piston extending from the outer portion of the opening to the second partial volume of the accumulator volume. The configuration of the bypass line running through the piston described herein is easy to implement.

In an alternative embodiment of the brake device, a pin is attached to the piston, which can be adjusted together with the piston, and which holds the check valve in its open state at least when the piston is in its normal position, while the check valve is switched to its closed state by means of the pin, which is adjusted together with the piston out of its normal position by at least the minimum adjustment travel. The configuration of the brake device described herein is also structurally easy to implement.

The advantages described above are also ensured in a hydraulic brake system for a vehicle having such a brake device with the brake cylinder attached to the first partial volume of the accumulator volume of the brake device and the wheel brake cylinder attached to the second partial volume of the accumulator volume.

Furthermore, performing a corresponding method for operating a hydraulic brake system of a vehicle also provides the advantages described above. It is expressly noted that the method for operating a hydraulic brake system of a vehicle can be further developed according to the embodiments of the brake device discussed above.

### BRIEF DESCRIPTION OF THE DRAWINGS

Further features and advantages of the present invention are explained below with reference to the figures. Shown are:

FIGS. 1a and 1b schematic representations of a first embodiment of the brake device;

FIGS. 2a to 2d schematic representations of a second embodiment of the brake device;

FIG. 3 a flowchart illustrating an embodiment of the method for operating a hydraulic brake system of a vehicle.

### EMBODIMENTS OF THE INVENTION

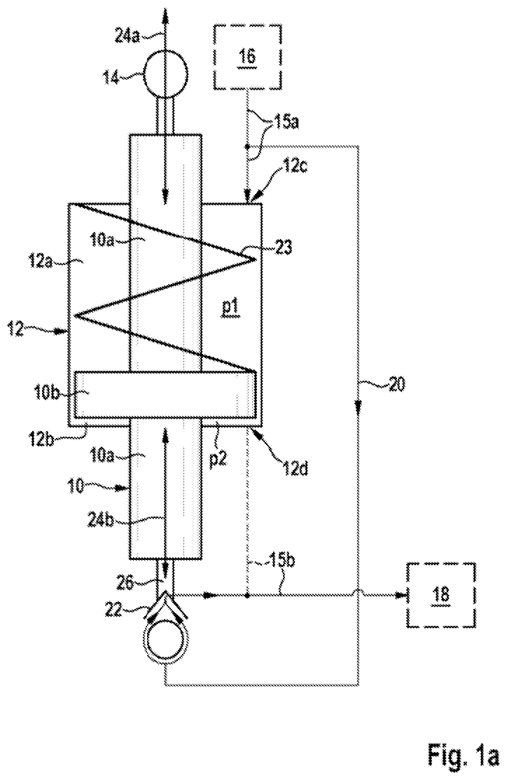

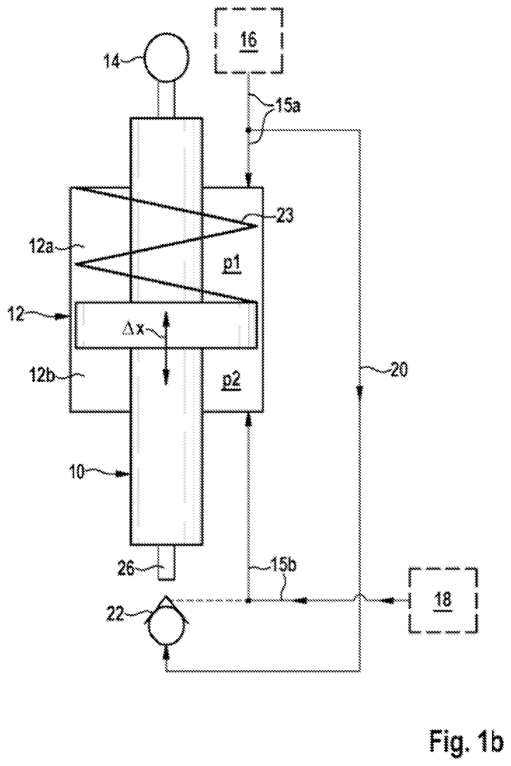

FIGS. 1a and 1b show schematic representations of a first embodiment of the brake device.

The brake device described in the following may be/is used as part of a hydraulic brake system of a vehicle. The usability of the brake device is not limited to any particular type of brake system. The vehicle equipped with the brake device may optionally be a vehicle with only two wheels or a vehicle with more than two wheels. The vehicle may also be understood to mean a vehicle without a motorized drive, for example a (muscle-powered) bicycle. However, the vehicle may also be a vehicle equipped with a motor drive, such as an electric bicycle, a motorcycle or in a motor vehicle, in particular a passenger car or a truck.

The brake device shown schematically in FIGS. 1a and 1b has a piston 10 which can be or is adjusted within an accumulator volume 12 of the brake device by means of an operation of a motor 14. The piston 10 divides the accumulator volume 12 into a first partial volume 12a and a second partial volume 12b. A brake cylinder 16 is (hydraulically) attached or can be attached to the first partial volume 12a of the accumulator volume 12, i.e., to a mouth 12c of the first partial volume 12a and/or to a first line component 15a that opens out at the first partial volume 12a. The brake cylinder 16 may be a brake cylinder 16 which is device-inherent or device-external. The brake cylinder 16 may be understood to mean a hydraulic device on which a brake actuating element can be arranged/is arranged in such a way that brake fluid is pushed out of or sucked in from the brake cylinder 16 by means of an increasing or decreasing actuation of the brake actuating element. The brake cylinder 16 may be a master brake cylinder, for example. The brake actuating element may in particular be understood as a brake pedal or a hand brake lever. The brake cylinder 16 can be attached/is attached to the first partial volume 12a of the accumulator volume 12 in such a way that brake fluid can be transferred/is transferred between the brake cylinder 16 and the first partial volume 12a.

A wheel brake cylinder 18 is (hydraulically) attached or can be attached to the second partial volume 12b of the accumulator volume 12, i.e., to a mouth 12d of the second partial volume 12b and/or to a second line component 15b that opens out at the second partial volume 12b. Although this is not illustrated in FIGS. 1a and 1b, at least one further wheel brake cylinder (not shown) can be attached/is attachable to the second partial volume 12b in addition to the wheel brake cylinder 18. The (at least one) wheel brake cylinder 18 may optionally be understood to mean a wheel brake cylinder 18 which is device-inherent or a wheel brake cylinder 18 which is device-external. The (at least one) wheel brake cylinder 18 can be attached or is attached to the second partial volume 12b in such a way that brake fluid is transferred/can be transferred between the second partial volume 12b and the (at least one) wheel brake cylinder 18.

A bypass line 20/bypass is also configured on the brake device in such a way that, at least when the piston 10 is in a so-called normal position, brake fluid can be transferred or is transferred from the first partial volume 12a and/or the brake cylinder 16 attached thereto via the bypass line 20 to the second partial volume 12b and/or the (at least one) wheel brake cylinder 18 attached thereto. For example, the bypass line 20 may extend from the first line component 15a to the second line component 15b. FIG. 1a shows the brake device with the piston 10 in its normal position. As long as brake fluid can be transferred from the first partial volume 12a and/or the brake cylinder 16 attached thereto via the bypass line 20 to the second partial volume 12b and/or the (at least one) wheel brake cylinder 18 attached thereto, a first pressure p1 present in the first partial volume 12a is equal to a second pressure p2 prevailing in the second partial volume 12b.

A check valve 22 arranged/configured in the bypass line 20, which can be switched or is switched by means of the piston 10 in such a way that the check valve 22 is in an open state at least in the case of the piston 10 being in its normal position, and is switched into a closed state by means of the piston 10, which is adjusted out of its normal position by at least a predetermined minimum adjustment travel Δx. The advantageous arrangement and configuration of the check valve 22, which can be switched by means of the piston 10, thus ensures that the transfer of brake fluid from the first partial volume 12a and/or the brake cylinder 16 attached thereto via the bypass line 20 to the second partial volume 12b and/or the (at least one) wheel brake cylinder 18 attached thereto, which can be carried out in the case that the piston 10 is in its normal position, is prevented by means of the piston 10 being adjusted out of its normal position by at least the predetermined minimum displacement path Δx. In addition, the piston 10 seals the first partial volume 12 from the second partial volume 12 in a liquid-tight manner in such a way that, after adjusting the piston 10 out of its normal position by at least the predetermined minimum adjustment travel Δx, as shown in FIG. 1b, the first pressure p1 present in the first partial volume 12a can deviate from the second pressure p2 prevailing in the second partial volume 12b.

While the piston 10 is in its normal position, a driver of the vehicle equipped with the brake device of FIGS. 1a and 1b can thus apply the brakes via the brake line 20 into the (at least one) wheel brake cylinder 18 by actuating the brake element arranged on the brake cylinder 16 and in this way cause a brake pressure increase in the (at least one) wheel brake cylinder 18 by means of the driver's braking force, which slows down the vehicle or brings it to a standstill. If piston 10 is in its normal position, there is therefore a mechanical fallback level on the brake device/the hydraulic brake system configured therewith. In addition, in the brake device of FIGS. 1a and 1b, the (at least one) wheel brake cylinder 18 is hydraulically disengaged from the brake cylinder 16 by adjusting the piston 10 out of its normal position by at least the minimum adjustment travel Δx in such a way that a braking pressure in the (at least one) wheel brake cylinder 18 can be modulated by means of a further adjustment of the piston 10. This means that an ABS function may be performed after adjusting the piston 10 by at least the predetermined minimum displacement travel Δx. The hydraulic brake system equipped with the brake device described herein may therefore be referred to as an ABS system.

The advantageous arrangement and configuration of the check valve 22 also eliminates the need for a configuration of the piston 10 to seal or disconnect the bypass line 20 by means of mechanical contact of the piston 10 with at least one inner wall of the accumulator volume 12, as required by the prior art described above. This also eliminates the requirement of the prior art for forming the piston 10 with a first surface of the piston 10 delimiting the first partial volume 12a greater than a second surface of the piston 10 delimiting the second partial volume 12b.

Furthermore, there is also no need to maintain a first pressure p1 in the first partial volume 12a above the second pressure p2 in the second partial volume 12b, so that the piston 10 seals the first partial volume 12a from the second partial volume 12b in a liquid-tight manner by increasing its diameter, as is still necessary in the prior art described above. Eliminating these conventional needs helps the piston 10 of the brake device described herein to be able to be adjusted out of its normal position by at least the minimum adjustment distance Δx by means of a comparatively small force. The energy consumption required to adjust the piston 10 out of its normal position by at least the minimum adjustment travel Δx is thus reduced compared to the prior art. Despite the advantages described herein, however, the mechanical fallback level when the piston 10 is in its normal position and the hydraulic decoupling of the (at least one) wheel brake cylinder 18 from the brake cylinder 16 by means of the piston 10, adjusted out of its normal position by at least the minimum adjustment distance Δx are still realized in the brake device in FIGS. 1a and 1b.

As soon as the motor 14 is stopped, the piston 10 may be returned to its normal position by means of an (optional) return spring 23. Once the piston 10 is in its normal position, the brake can be applied again via the brake cylinder 16 in the (at least one) wheel brake cylinder 18. In addition, it is ensured that the check valve 22 is returned to its open state once the piston 10 is in its normal position.

Advantageously, in the embodiment of FIGS. 1a and 1b, the piston 10 is configured/shaped in such a way that the piston 10 comprises a cylindrical base body 10a with a ring portion 10b projecting from the base body 10a. The ring portion 10b is fixedly attached to the base body 10a. Preferably, the base body 10a and the ring portion 10b are formed together as a compact component, for example, cast/injection-molded together. The ring portion 10b seals the first partial volume 12a of the accumulator volume 12 lying on a first side of the ring portion 10b from the second partial volume 12b of the accumulator volume 12 lying on a second side of the ring portion 10b in a liquid-tight manner. In contrast, the cylindrical base body 10a extends continuously through the accumulator volume 12 from a first recess 24a on the first side of the ring portion 10b to a second recess 24b lying on the second side of the ring portion 10b. The form of the piston 10 described herein contributes to an additional reduction in a force necessary to adjust it, and thus also to the energy consumption required to adjust the piston 10.

In the embodiment shown in FIGS. 1a and 1b, a pin 26 is attached to the piston 10 by way of example, which is or can be adjusted together with the piston 10. The pin 26 can also be manufactured together with the piston 10 as a compact component, for example cast/injection-molded together. The pin 26 holds the check valve 22 in its open state, at least when the piston 10 is in its normal position. In addition, the pin 26 is adjusted or is adjusted together with the piston 10, which is adjusted out of its normal position by at least the minimum adjustment travel Δx in such a way that the check valve 22 is switched to its closed state by means of the adjusted pin 26. In particular, the valve 22 may be configured in such a way that the check valve 22 (automatically) transitions to its closed state when the pin 26, which is adjusted together with the piston 10, is removed by at least the minimum adjustment travel Δx away from the check valve 22. For example, this can be realized by configuring the check valve 22 with a spring device whose force acts in such a way that, as soon as the pin 26 no longer counteracts the force of the spring device of check valve 22, the force of the spring device transfers the check valve 22 into its closed state. However, the configuration of the piston 10 described herein, with the pin 26 attached thereto, is to be interpreted by way of example only.

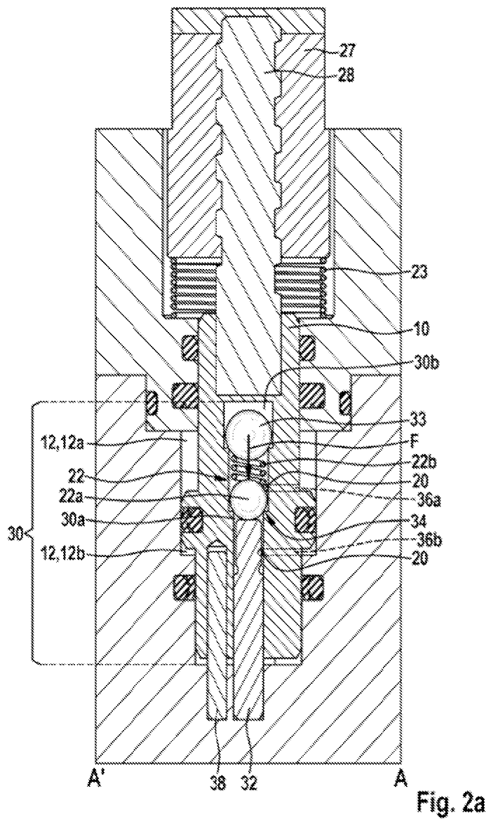

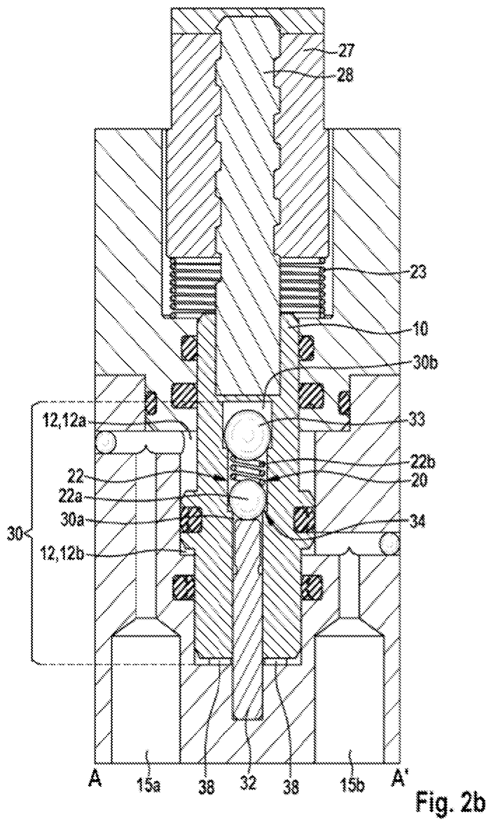

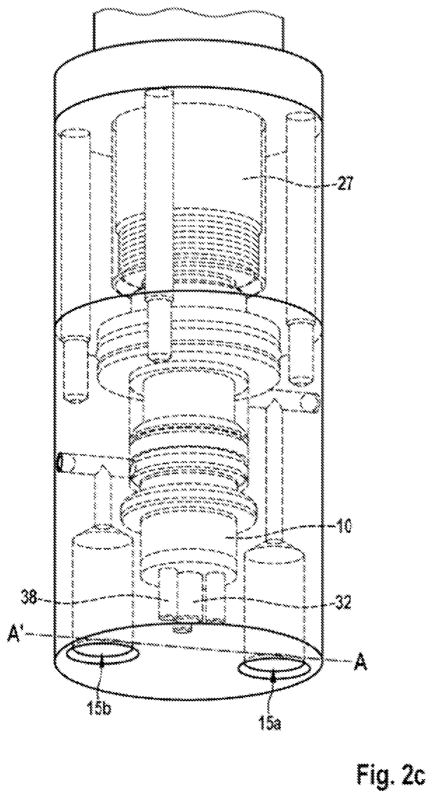

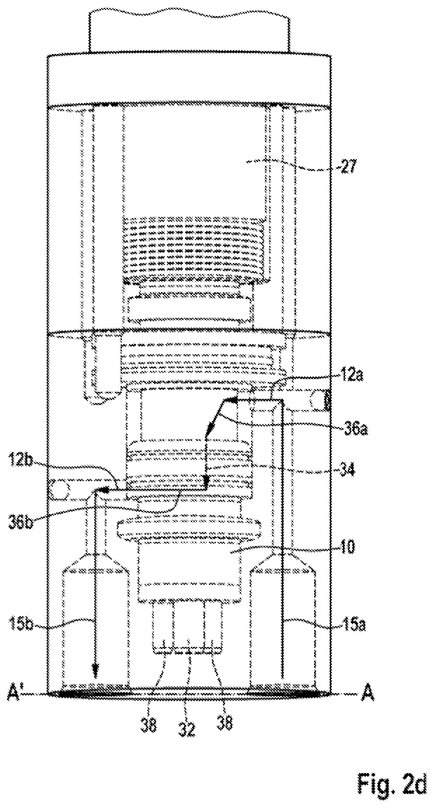

FIGS. 2a to 2d show schematic representations of a second embodiment of the brake device.

The embodiment described herein is shown in both FIGS. 2a and 2b as a cross-section along line AA′ of FIGS. 2c and 2d, wherein a viewer of FIGS. 2a and 2b looks at different sides along line AA′. The usability of the brake device in FIGS. 2a to 2d is not limited to either a particular type of brake system or a particular type of vehicle/type of motor vehicle.

FIGS. 2a and 2b each show the piston 10 in its normal position. The piston 10 is held in its normal position primarily by means of the force of the return spring 23, which can be configured as a rotary spring, by way of example. In addition, if the first pressure p1 present in the first partial volume 12a is greater than the second pressure p2 present in the second partial volume 12b, the piston 10 may also be pushed to its normal position by means of a resulting pressurization. An operation of the motor 14 causes a nut 27 to rotate, which is translated into linear movement of the piston 10 out of its normal position by means of a spindle 28. Preferably, the spindle 28 is pressed into the piston 10. In the embodiment described herein, the spindle 28 is designed as a non-self-inhibiting, steep-thread spindle, which causes an automatic return movement of the piston 10 adjusted out of its normal position back to its normal position when the motor 14 is switched off due to the force of the return spring 23 and possibly the pressurization. Active motor support of the motor 14 is thus not necessary to return the piston 10 to its normal position.

As can be seen from FIGS. 2a to 2d, in this embodiment, the bypass line 20 and check valve 22 are configured within the piston 10. The bypass line 20 and the check valve 22 can also be said to be integrated into the piston 10. When the piston 10 is in its normal position, the check valve 22 configured within the piston 10 is held in its open state by means of a plunger 32 fixedly arranged on the brake device and projecting into an opening 30 of the piston 10. The plunger 32 is fixedly arranged/attached to the brake device in such a way that an adjustment movement of the piston 10 adjusted by means of the motor 14 causes a relative movement of the plunger 32 within the opening 30. This relative movement of the plunger 32 may be described as “pulling the plunger 32 into the opening 30” or “pulling the plunger 32 out of the opening 30”. In this way, the check valve 22 is switched to its closed state as soon as the piston is adjusted out of its normal position by at least the minimum displacement travel Δx relative to the plunger 32.

The opening 30 comprises an outer portion 30a and an inner portion 30b, which are configured such that a maximum surface area of a cross-section of the outer portion 30a aligned perpendicular to a longitudinal direction of the opening 30 is less than a maximum surface area of a cross-section of the inner portion 30b aligned perpendicular to the longitudinal direction of the opening 30. A narrowing/constriction 34, such as a radial step 34, is configured at the opening between the outer portion 30a and the inner portion 30b.

Advantageously, the check valve 22 configured within the piston 10 comprises a valve body 22a and a spring device 22b, which are arranged within the opening 30. The valve body 22a may be spherical. To support the spring device 22b on its side facing away from valve body 22a, a spherical spring seat 33 can be fastened in the opening 30 of the piston 10.

As can be seen in FIGS. 2a and 2b, when the piston 10 is in its normal position, the valve body 22a is held away from the constriction 34 configured at the opening 30 by means of the plunger 32 projecting into the opening 30 of piston 10 against a force F of the spring device 22b. When the piston 10 is in its normal position, there is therefore no mechanical contact between the valve body 22a and the constriction 34. Conversely, when the piston 10 is adjusted out of its normal position by at least the minimum adjustment travel Δx (and “pulling the plunger 32 out of opening 30” by at least the minimum adjustment travel Δx), the force F of the spring device 22b pushes the valve body 22a against the constriction 34 in such a way that that the outer section 30a of the opening 30 is sealed from the inner section 30b of the opening 30 in a liquid-tight manner by means of the mechanical contact of valve body 22a with the constriction 34.

The bypass line 20 formed within the piston 10 may comprise a first radial contact bore 36a through the piston 10 extending from the first partial volume 12a of the accumulator volume 12 to the inner portion 30b of the opening 30, and a second radial contact bore 36b through the piston 10 extending from the outer portion 30a of the opening 30b to the second partial volume 12b of the accumulator volume 12.

When the piston 10 is in its normal position, due to the mechanical contact between the valve body 22a and the constriction 34 prevented by the plunger 32, there may be a transfer of brake fluid between first partial volume 12a of accumulator volume 12 and second partial volume 12b of accumulator volume 12 through the first radial contact bore 36a, the constriction 34 of the opening 30 and the second radial contact bore 36b. Therefore, the check valve 22 is in in its open state when the piston 10 is in its normal position. Conversely, when the piston 10 is adjusted out of its normal position by at least the minimum adjustment travel Δx (and “pulling the plunger 32 out of the opening 30” by at least the minimum adjustment travel Δx), the constriction 34 of the opening 30 is sealed by means of the mechanical contact of the valve body 22a with the constriction 34, in such a way that a transfer of brake fluid transfer is prevented between the first partial volume 12a and the second partial volume 12b and the check valve 22 is transitioned to its closed state. As soon as the check valve 22 is closed, volume can be sucked from the (at least one) wheel brake cylinder 18 into the accumulator volume 12 by means of a further stroke of the piston 10, whereby a modulation of the brake pressure in the (at least one) wheel brake cylinder 18 can be achieved. Even during modulation, the check valve 22 remains in its closed state due to the maintained mechanical contact of the valve body 22a with the constriction 34. Only by returning the piston 10 to its normal position will the mechanical contact of valve body 22a with constriction 34 be lifted by “pulling the plunger 32 into the opening 30” and the check valve 22 is transitioned to its open state.

As can additionally be seen in FIGS. 2a to 2d, the piston 10 can be guided by means of at least one guide pin 38. The at least one guide pin 38 may be attached to the piston 10 and project into at least one guide opening external to the piston. Alternatively, the at least one guide pin 38 may also be attached externally to the piston 10 and project into at least one guide opening formed on the piston 10. Purely by way of example, in the embodiment shown in FIGS. 2a to 2d, the piston 10 is guided by means of three guide pins 38.

With regard to further features and properties of the brake device shown in FIGS. 2a and 2d and its advantages, reference is made to the description of FIGS. 1a and 1b.

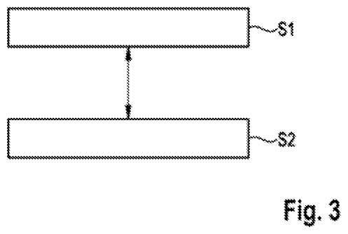

FIG. 3 shows a flowchart illustrating an embodiment of the method for operating a hydraulic brake system of a vehicle.

The method described in the following may be performed with (almost) any hydraulic brake system of a vehicle equipped with a piston which can be adjusted within an accumulator volume of the hydraulic brake system and which divides the accumulator volume into a first partial volume and a second partial volume.

In a method step S1, a bypass line, via which brake fluid can be transferred from the first partial volume and/or a brake cylinder attached to the first partial volume to the second partial volume and/or a wheel brake cylinder attached to the second partial volume at least in its normal position, is switched open and/or held open. For this purpose, a check valve arranged in the bypass line, which is in an open state at least when the piston is in its normal state, is transferred and/or held in the open state by adjusting and/or holding the piston in its normal position.

In contrast, in a method step S2, the transfer of brake fluid via/through the bypass line is interrupted by adjusting the piston out of its normal position by at least a predetermined minimum adjustment travel. This is achieved by adjusting the piston out of its normal position by at least the predetermined minimum adjustment travel by means of an operation of a motor and switching the check valve into a closed state by means of the piston adjusted out of its normal position by at least the predetermined minimum adjustment travel.

The method steps S1 and S2 can be carried out alternately.

1. A brake device for a hydraulic brake system of a vehicle, comprising:
a motor;
a piston configured to be adjusted within an accumulator volume by way of an operation of the motor, which divides the accumulator volume into a first partial volume and a second partial volume, wherein a brake cylinder which is device-inherent or device-external is attached or is configured to be attached to the first partial volume in such a way that brake fluid can be transferred between the brake cylinder and the first partial volume, and a wheel brake cylinder which is device-inherent or device-external is attached or is configured to be attached to the second partial volume in such a way that brake fluid can be transferred between the second partial volume and the wheel brake cylinder;
a bypass line, wherein, at least when the piston is in its normal position, brake fluid can be transferred from the first partial volume and/or the brake cylinder attached thereto via the bypass line to the second partial volume and/or the wheel brake cylinder attached thereto, while this transfer of brake fluid via the bypass line is prevented by way of the piston which is adjusted out of its normal position by at least one predetermined minimum adjustment travel; and
a check valve arranged in the bypass line which is configured to be switched by way of the piston in such a way that the check valve is in an open state at least in the case of the piston being in its normal position, and is switched into a closed state by way of the piston which is adjusted out of its normal position by at least the minimum adjustment travel.

2. The brake device according to claim 1, wherein:
the piston comprises a cylindrical base body with a ring portion projecting from the base body,
the ring portion of the piston seals the first partial volume of the accumulator volume lying on a first side of the ring portion from the second partial volume of the accumulator volume lying on a second side of the ring portion in a liquid-tight manner, and
the cylindrical base body extends continuously from a first recess lying on the first side of the ring portion through the accumulator volume to a second recess lying on the second side of the ring portion.

3. A brake device according to claim 1, wherein the piston is guided by way of at least one guide pin.

4. The brake device of claim 1, wherein the bypass line and the check valve are formed within the piston.

5. The brake device according to claim 4, wherein:
when the piston is in its normal position, the check valve is held in its open state by way of a plunger which is fixedly arranged on the brake device and projects into an opening of the piston, while the piston, which is adjusted from its normal position by at least the minimum adjustment travel, is adjusted relative to the plunger in such a way that the check valve is switched to its closed state.

6. The brake device according to claim 5, wherein:
the check valve comprises a valve body and a spring device, and
the valve body is held away from a constriction formed at the opening of the piston against a force of the spring device when the piston is in its normal position by way of the plunger projecting into the opening of the piston, while after the piston has been adjusted out of its normal position by at least the minimum adjustment travel, the force of the spring device pushes the valve body against the constriction in such a way that, by way of the mechanical contact of the valve body with the constriction, an outer portion of the opening lying on a first side of the constriction is sealed in a liquid-tight manner from an inner portion of the opening lying on a second side of the constriction.

7. The brake device according to claim 6, wherein the bypass line comprises a first radial contact bore through the piston extending from the first partial volume of the accumulator volume to the inner portion of the opening, and a second radial contact bore through the piston extending from the outer portion of the opening to the second partial volume of the accumulator volume.

8. The brake device according to claim 1, further comprising a pin attached to the piston, which is configured to be adjusted together with the piston, and which holds the check valve in its open state at least when the piston is in its normal position, while the check valve is switched to its closed state by way of the pin, which is adjusted together with the piston from its normal position by at least the minimum adjustment travel.

9. A hydraulic brake system for a vehicle, comprising:
a brake device according to claim 1,
wherein the brake cylinder is attached to the first partial volume of the accumulator volume of the brake device; and
wherein the wheel brake cylinder is attached to the second partial volume of the accumulator volume.

10. A method for operating a hydraulic brake system of a vehicle with a piston which can be adjusted within an accumulator volume of the hydraulic brake system and divides the accumulator volume into a first partial volume and into a second partial volume, the method comprising:
preventing a transfer of brake fluid over a bypass line, via which, at least when the piston is in its normal position, brake fluid can be transferred from the first partial volume and/or the brake cylinder attached to the second partial volume and/or the wheel brake cylinder attached to the second partial volume, by adjusting the piston out of its normal position by at least one predetermined minimum adjustment travel by way of an operation of a motor;
wherein a check valve arranged in the bypass line is in an open state at least in the case of the piston being in its normal position, and is switched into a closed state by way of the piston, which is adjusted out of its normal position by at least the minimum adjustment travel.
